(19) United States
(12) Patent Application Publication
(10) Pub. No.: US 2026/0151808 A1
(43) Pub. Date: Jun. 4, 2026

(54) METHODS AND SYSTEMS FOR THE RECOVERY AND REUSE OF CONDUCTIVE ADDITIVES FOR FLASH JOULE HEATING

(71) Applicant: William Marsh Rice University, Houston, TX (US)

(72) Inventors: James M. TOUR, Houston, TX (US); Bing DENG, Houston, TX (US)

(73) Assignee: WILLIAM MARSH RICE UNIVERSITY, Houston, TX (US)

(21) Appl. No.: 19/125,392

(22) PCT Filed: Oct. 30, 2023
(86) PCT No.: PCT/US2023/078213

§ 371 Date: Apr. 29, 2025

Related U.S. Application Data
(63) Continuation of application No. PCT/US2023/065506, filed on Apr. 7, 2023.
(60) Provisional application No. 63/420,282, filed on Oct. 28, 2022.
(60) Provisional application No. 63/589,489, filed on Oct. 11, 2023.

(51) Int. Cl. B09C 1/08; B09C 1/06

(52) U.S. Cl. CPC B09C 1/08; B09C 1/06

(57) ABSTRACT

Methods and systems for the recovery and reuse of conductive additives for flash Joule heating. The conductive additives utilized or flash Joule heating for materials such as e-waste, ores, fly ash, soil, and/or bauxite residue can be recovered at high recovery yields greater than 85%, which can then be reused for further flash Joule heating processes. The conductive additives can be separated from the products of the flash Joule heating process, such as by sieving or by centrifugation, filtering, and drying.

### CROSS-REFERENCED TO RELATED PATENT APPLICATIONS

The application claims priority to: (1) U.S. Patent Appl. Ser. No. 63/420,282, filed Oct. 28, 2022, entitled “Methods And Systems For The Recovery And Reuse Of Conductive Additives For Flash Joule Heating;” (2) PCT Patent Appl. Serial No. PCT/US23/65506, entitled “Heavy-Metal-Reduced Post-Industrial Waste In Cementitious Materials And Methods Of Making And Using Thereof,” filed Apr. 7, 2023; and (3) U.S. Patent Appl. Ser. No. 63/589,489, entitled “Methods For Remediation Of PFAS-Contaminated Soil By Rapid Electrothermal Mineralization,” filed Oct. 11, 2023.

The methods and systems of the present invention are also related to PCT Patent Appl. Serial Nos. PCT/US21/52030, PCT/US21/52043, PCT/US21/52057, and PCT/US21/52070, to James M. Tour et al., each entitled “Ultrafast Flash Joule Heating Synthesis Methods And Systems For Performing Same,” each filed Sep. 24, 2021.

Each of these patent applications is commonly owned by the owner of the present invention and is incorporated herein in its entirety.

### GOVERNMENT INTEREST

This invention was made with government support under Grant No. FA9550-22-1-0526, awarded by the United States Air Force Office of Scientific Research, and Grant No. W912HZ-21-2-0050, awarded by the United States Army Corps of Engineers, Engineer Research and Development Center. The government has certain rights in the invention.

### TECHNICAL FIELD

The present invention relates to methods and systems for the recovery and reuse of conductive additives for flash Joule heating.

### BACKGROUND

Flash Joule heating (FJH), featured with ultrafast treating duration and ultralow energy consumption, has been an innovative method for functional materials production [Luong 2020; Chen I 2021; Deng I 2022; Stanford 2020] and sustainable waste management [Luong 2020; Algozeeb 2020; Barbhuiya 2021; Wyss 2021; Wyss 2022; Chen II 2021. For example, the applications of the FJH process has been reported for precious metals recovery from electronic wastes (e-wastes), the heavy metal removal from e-waste, coal fly ash and contaminated soil, the rare earth recovery from coal fly ash, bauxite residue and e-wastes, etc. [Deng 2021; Deng II 2022].

In the FJH process, when an insulative inorganic or organic material is used, conductive additives should be added and mixed with the inorganic material to ensure a good conductivity. The applicable conductive additives include many kinds of carbon, metals, etc. The conductive additives usually constitute a large portion of the materials cost of the FJH process. Hence, the recovery and reuse of the conductive additive is often desired for FJH processes to reduce the materials cost.

Chemical processes could be used for the removal of conductive additives. For example, for the transition metal carbide synthesis by flash Joule heating, the carbon additives were removed by a calcium etching protocol [Deng I 2022]: for the corundum nanoparticle synthesis by the pulsed direct current heating process, the carbon additives were removed by calcination in air [Deng III 2022]. However, these processes are energy-consuming, and the carbon additives could not be recovered and reused.

Accordingly, a need remains for the recovery and reuse of conductive additives for flash Joule heating.

### SUMMARY OF THE INVENTION

The present invention relates to methods and systems for the recovery and reuse of conductive additives for flash Joule heating.

In general embodiments, the present invention is directed to a method that includes mixing a first material with a conductive additive to form a first mixture. The method further includes performing a flash Joule heating process of the first mixture to form a product. The product includes a resultant conductive additive in the first mixture. The resultant conductive additive is selected from the group consisting of (i) the conductive additive, (ii) a different conductive additive, and (iii) a combination thereof. The method further includes separating at least some of the resultant conductive additive from the product to obtain recovered conductive additive. The method further includes using the recovered conductive additive in a second flash Joule heating process. The recovered conductive material is mixed with a second material for use in a second flash Joule heating process. The second material is the same or different material as the first conductive material.

Implementations of the invention can include one or more of the following features:

The resultant conductive additive can include the conductive additive.

The resultant conductive additive can include the different conductive additive.

The method can further include, from a second product formed in the second flash Joule heating process, separating at least some of a second resultant conductive additive from the second product to obtain second recovered conductive additive. The method can further include using the second recovered conductive additive in a third flash Joule heating process. The second recovered conductive additive can be mixed with a third material for use in the third flash Joule heating process. The third material can be the same or different material as the first material and/or the second material.

The steps of separating and reusing the recovered conductive additive can be repeated for a plurality of additional flash Joule heating processes performed in series.

The additional conductive additive can be mixed to the recovered conductive additive and the second material before performing the second flash Joule heating process.

The first material can be prepared from e-waste, ores, fly ash, soil, and/or bauxite residue.

The second material can be prepared from e-waste, ores, fly ash, soil, and/or bauxite residue.

The first material can be soil.

The soil can be a contaminated soil that includes a pollutant selected from the group consisting of heavy metals, persistent organic pollutants, and poly- and perfluorinated alkyl substances (PFAS).

The pollutant can be a heavy metal selected from the group consisting of lead (Pb), arsenic (As), zinc (Zn), cobalt (Co), cadmium (Cd), copper (Cu), mercury (Hg), and nickel (Ni).

The pollutant can be a persistent organic pollutant selected from group consisting of polycyclic aromatic hydrocarbons, polychlorinated biphenyl, organochlorine pesticides, total petroleum hydrocarbons, and PFAS.

The soil can be a contaminated soil that includes a persistent and bioaccumulative pollutant.

The persistent and bioaccumulative pollutant can include one or more per- and polyfluoroalkyl substances (PFAS).

The first material can be fly ash.

The conductive additive can be selected from a group consisting of elemental carbon, carbon black, graphene, flash graphene, coal, anthracite, coke, metallurgical coke, calcined coke, activated charcoal, biochar, natural gas carbon that had been stripped of its hydrogen atoms, activated charcoal, shungite, plastic waste, plastic waste-derived carbon char, food waste, food waste-derived carbon char, biomass, biomass-derived carbon char, hydrocarbon gas products, metals, and mixtures therefrom.

The conductive additive can be selected from the group consisting of metallurgical coke (metcoke), bituminous activated charcoal (BAC), and combinations thereof.

The conductive additive can be biochar.

The conductive additive can be a fiber and/or graphite.

The conductive additive can be a carbon fiber.

The metal can be selected from the group consisting of metal particles, metal alloys, and metal carbides.

The metal can include metal particles that include titanium.

The metal can be selected from the group of metal nanoparticles, metal microparticles, metal milliparticles, and metal centiparticles.

The metal can include metal carbides that include tungsten carbide.

The step of separating at least some of the resultant conductive additive from the product to obtain recovered conductive additive can be a sieving process.

The step of separating at least some of the resultant conductive additive from the product to obtain recovered conductive additive can be based upon grain size of the conductive additive and particle size of the product.

The step of separating can include sieving to separate the at least some of the resultant conductive additive from the product.

The step of separating at least some of the resultant conductive additive from the product to obtain recovered conductive additive can be based upon difference in densities between the conductive additive and the product. Often the carbon additive will float in water. Often metallic additive will sink in water.

The step of separating can be utilizing a liquid to separate the at least some of the resultant conductive additive from the product.

The liquid can be selected from the group consisting of water, a salt dissolved in water, an organic solvent, and an ionic liquid.

The liquid can be water.

The at least some of the resultant conductive additive can float at or near the top surface of the liquid utilized for separating.

The conductive additive can be a conductive carbon additive.

The step of separating can include decanting and/or skimming the at least some of the resultant conductive additive from the product.

The at least some of the conductive additive sinks in the liquid utilized for separating.

The conductive additive includes metal.

The recovery yield of the conductive additive can be at least 85%. The recovery yield of the conductive additive is the weight of the recovered conductive additive recovered from the product divided by the weight of the conductive additive in the first mixture.

The recovery yield can be at least 90%.

The recovery yield can be at least 92%.

The recovery yield can be at least 95%.

In further general embodiments, the present invention is directed to a system that includes a first source of a first mixture of a first material mixed with a conductive additive. The system further includes a flash Joule heating system that includes (i) a cell operably connected to the first source such that the first mixture can be flowed into the cell and held under compression, (ii) electrodes operatively connected to pressure cell, and (iii) a flash power supply for applying a voltage across the mixture to perform a flash Joule heating process to form a product that includes a resultant conductive additive of the first mixture. The resultant conductive additive is selected from the group consisting of (i) the conductive additive, (ii) a different conductive additive, and (iii) a combination thereof. The system further includes a separator to separate some of the resultant conductive additive from the product to obtain recovered conductive additive. The system further includes a mixer to mix the recovered conductive additive with a second material to form a second mixture. The second material is the same or different material as the first material. The system further includes a second source of the second mixture that is operable connected to the flash Joule heating system for use of the second mixture in the flash Joule heating system.

Implementations of the invention can include one or more of the following features:

The resultant conductive additive can include the conductive additive.

The resultant conductive additive can include the different conductive additive.

The system can be operable for separating and reusing the recovered conductive additive repeatedly for a plurality of additional Joule heating processes performed in series.

The system can include a second source of additional conductive material. The additional source can be operably connected to the mixer such that the additional conductive material is mixed with the recovered conductive additive and the second material in the mixer to form the second mixture.

The first material can be prepared from e-waste, ores, fly ash, soil, and/or bauxite residue.

The second material can be prepared from e-waste, ores, fly ash, soil, and/or bauxite residue.

The first material can be soil.

The soil can be a contaminated soil that includes a pollutant selected from the group consisting of heavy metals, persistent organic pollutants, and poly- and perfluorinated alkyl substances (PFAS).

The pollutant can be a heavy metal selected from the group consisting of lead (Pb), arsenic (As), zinc (Zn), cobalt (Co), cadmium (Cd), copper (Cu), mercury (Hg), and nickel (Ni).

The pollutant can be a persistent organic pollutant selected from the group consisting of polycyclic aromatic hydrocarbons, polychlorinated biphenyl, organochlorine pesticides, total petroleum hydrocarbons, and PFAS.

The soil can be a contaminated soil that includes a persistent and bioaccumulative pollutant.

The persistent and bioaccumulative pollutant can include one or more per- and polyfluoroalkyl substances (PFAS).

The first material can be fly ash.

The conductive additive can be selected from a group consisting of elemental carbon, carbon black, graphene, flash graphene, coal, anthracite, coke, metallurgical coke, calcined coke, activated charcoal, biochar, natural gas carbon that had been stripped of its hydrogen atoms, activated charcoal, shungite, plastic waste, plastic waste-derived carbon char, food waste, food waste-derived carbon char, biomass, biomass-derived carbon char, hydrocarbon gas products, metals, and mixtures therefrom.

The conductive additive can be selected from the group consisting of metallurgical coke (metcoke), bituminous activated charcoal (BAC), and combinations thereof.

The conductive additive can be biochar.

The conductive additive can be a fiber and/or graphite.

The conductive additive can be a carbon fiber

The metal can be selected from the group consisting of metal particles, metal alloys, and metal carbides.

The metal can include metal particles that includes titanium.

The metal can be selected from the group of metal nanoparticles, metal microparticles, metal milliparticles, and metal centiparticles.

The metal can include metal carbides that include tungsten carbide.

The separator can be a sieve.

The separator can be operable to separate at least some of the resultant conductive additive from the product to obtain recovered conductive additive based upon grain size of the conductive additive and particle size of the product.

The separator can include a sieve to separate the at least some of the resultant conductive additive from the product based upon the grain size of the conductive additive and the particle size of the product.

The separator can be operable to separate at least some of the resultant conductive additive from the product to obtain recovered conductive additive based upon difference in densities between the conductive additive and the product.

The system can further include a liquid. The separator can be operable to utilize the liquid to separate the at least some of the resultant conductive additive from the product.

The liquid can be selected from the group consisting of water, a salt dissolved in water, an organic solvent, and an ionic liquid

The liquid can be water.

The separator can be operable for at least some of the resultant conductive carbon additive to float at or near the top surface of the liquid in the separator.

The conductive additive can be a conductive carbon additive.

The separator can include a decantor and/or skimmer for decanting and/or skimming the at least some of the resultant conductive additive from the product.

The at least some of the resultant conductive additive can sink in the liquid utilized for separating.

The conductive can include metal.

The system can have a recovery yield of the conductive additive that is at least 85%. The recovery yield of the conductive additive is the weight of the recovered conductive additive recovered from the product divided by the weight of the conductive additive in the first mixture.

The recovery yield can be at least 90%.

The recovery yield can be at least 92%.

The recovery yield can be at least 95%.

### BRIEF DESCRIPTION OF THE DRAWINGS

FIG. 1 shows carbon residue after soil remediation using a flash Joule heating (FJH) process. FIG. 1 is a TGA curve of the remediated soil with residual carbon. TGA was conducted in air with the heating rate of 10° C. min⁻¹.

FIGS. 2A-2F show separation and reuse of metallurgical coke (metcoke) from soil after remediation by an FJH process. FIG. 2A is a picture of the mixture of soil/metcoke before FJH. FIG. 2B is a picture of the mixture of soil/metcoke after FJH. FIG. 2C shows the separation of soil and metcoke by sieving. FIG. 2D is a picture of the separated soil and metcoke. FIG. 2E is a picture of the mixture of soil/metcoke after FJH. (The metcoke is mostly recovered from previous FJH trail.) FIG. 2F is a picture of the separated soil and metcoke.

FIGS. 3A-3B show Raman spectrum of metcoke. FIG. 3A is Raman spectrum of the metcoke raw materials. FIG. 3B is Raman spectrum of metcoke after FJH and separation. The Raman spectra showed that the metcoke was converted into to flash graphene after the FJH process.

FIGS. 4A-4B show soil carbon content measurement. FIG. 4A is a calibration curve for the soil carbon content measurement. FIG. 4B shows soil carbon content in the raw soil and the treated soil after removal of the carbon additives by sieving.

FIGS. 5A-5F show separation and reuse of the carbon additive, bituminous activated charcoal (BAC). FIG. 5A is a picture of the mixture of soil and BAC. FIG. 5B is a picture of the mixture of soil and BAC after FJH. FIG. 5C shows the separation of soil and BAC by sieving. FIG. 5D is a picture of the separated treated soil and recovered BAC. FIG. 5E is a picture of the mixture of soil and reused BAC after FJH. FIG. 5F is a picture of the separated treated soil and recovered BAC.

FIGS. 6A-6E shows recycling biochar from treated soil. FIG. 6A is a picture of initial biochar before a rapid electrothermal mineralization (REM) process. FIG. 6B is a picture of the mixture of soil/biochar before REM. FIG. 6C is a picture of the mixture of soil/biochar after REM. FIG. 6D is a picture of REM soil mixed with biochar dispersant after centrifugation. FIG. 6E is a picture of recycled biochar after REM, dispersion, centrifugation and drying.

FIGS. 7A-7B show comparison of biochar and recycled biochar. FIG. 7A is XRD patterns; and FIG. 7B is Raman spectra.

FIGS. 8A-8C is TGA results of soil. FIG. 8A is of raw soil (PFAS-contaminated soil). FIG. 8B is of REM-treated soil mixed with biochar. FIG. 8C is of REM-treated soil after removing biochar by centrifugation. TGA test was conducted in air with the heating rate of 10° C. min⁻¹.

FIG. 9 shows PFOA mineralization ratio using biochar and recycled biochar as the conductive additives after REM treatment. The REM process was conducted with an input voltage of 100 V and the duration time of 1 s for one time. The error bars denote the standard deviation, where N=3.

FIGS. 10A-10C show separation and recycling of the conductive additive, metcoke from soil. FIG. 10A is a picture of the mixture of soil/metcoke before REM process. FIG. 10B is a picture of the mixture of soil/metcoke after REM process. FIG. 10C shows separation of REM-treated soil and metcoke by sieving.

FIGS. 11A-11B show Raman spectra of metcoke and recycled metcoke. FIG. 11A shows initial metcoke before REM; and FIG. 11B shows recycled metcoke after REM.

FIG. 12 shows perfluorooctanoic acid (PFOA, a specific type of PFAS) mineralization ratio using metcoke and recycled metcoke as the conductive additives after REM treatment. The REM process was conducted with an input voltage of 100 V and the duration time of 1 s for one time. The error bars denote the standard deviation, where N=3.

FIG. 13A-13F show separation and reuse of the carbon additives. FIG. 13A is a picture of the mixture of coal fly ash (CFA) and metallurgical coke (metcoke). FIG. 13B is a picture of the mixture of CFA and metcoke after flash Joule heating (FJH). FIG. 13C shows the separation of CFA and metcoke by sieving. FIG. 13D is a picture of the separated CFA and recovered metcoke. FIG. 13E is a picture of the mixture of CFA and recovered metcoke after FJH. FIG. 13F is a picture of the separated CFA and recovered metcoke.

FIG. 14 shows residual carbon in the CFA sample after sieving separation (TGA curve of purified CFA after CB removal by sieving). TGA was conducted in air with the heating rate of 10° C./min.

FIG. 15 is a flow diagram of an embodiment of a method of the present invention.

FIG. 16 is a schematic of an embodiment of a system of the present invention.

### DETAILED DESCRIPTION

The present invention relates to methods and systems for the recovery and reuse of conductive additives for flash Joule heating.

In FJH processes, conductive additives can be added and mixed with the inorganic material to ensure a good conductivity, such as when an insulative inorganic material is used in the FJH process. Based on the physical properties difference between the treated inorganic materials (or other materials utilized in the FJH process) and the carbon conductive additives, it is possible to separate them and recover and reuse the conductive additives. The use of relatively large-grained carbon as the conductive additives, and the separation of carbon additives with inorganic materials can be performed, such as by a simple, cost-efficient sieving process. Various large-grained carbon additives could be used, including metallurgical coke (metcoke), and bituminous activated charcoal (BAC). This process is applicable to many inorganic materials (or other materials) with the feature of fine powder, exemplified by the coal fly ash (CFA) and contaminated soil.

Carbon Residues after FJH Processes

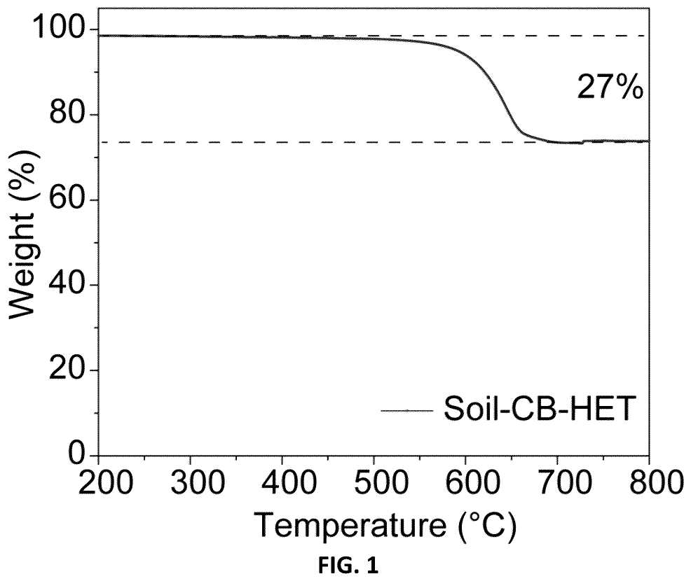

After FJH treatment processes, there is considerable residual carbon content in the remaining solid. For example, for soil remediation by FJH, the contaminated soil is mixed with carbon additives with mass ratio of 2:1. After the FJH purification process, the residual carbon has the mass of ˜27 wt %, according to the thermogravimetric analysis (TGA), as shown in FIG. 1. During the FJH process, the easy-to-decompose components in the soil were decomposed. Hence, in the TGA measurement, most of the weight loss was ascribed to the residual carbon.

### Recovery and Reuse for Soil

### Heavy Metals/Persistent Organic Pollutants Contaminated Soil

The FJH process can be utilized to remediate soil contaminated with pollutants such as heavy metals, including lead (Pb), arsenic (As), zinc (Zn), cobalt (Co), cadmium (Cd), copper (Cu), mercury (Hg), and nickel (Ni), as well as persistent organic pollutants (POP), such as polycyclic aromatic hydrocarbons (PAH), polychlorinated biphenyl, organochlorine pesticides, total petroleum hydrocarbons, and PFAS. The FJH process to remediate such multiple pollutants in contaminated soil can also be referred to as a high-temperature electrothermal (HET) process.

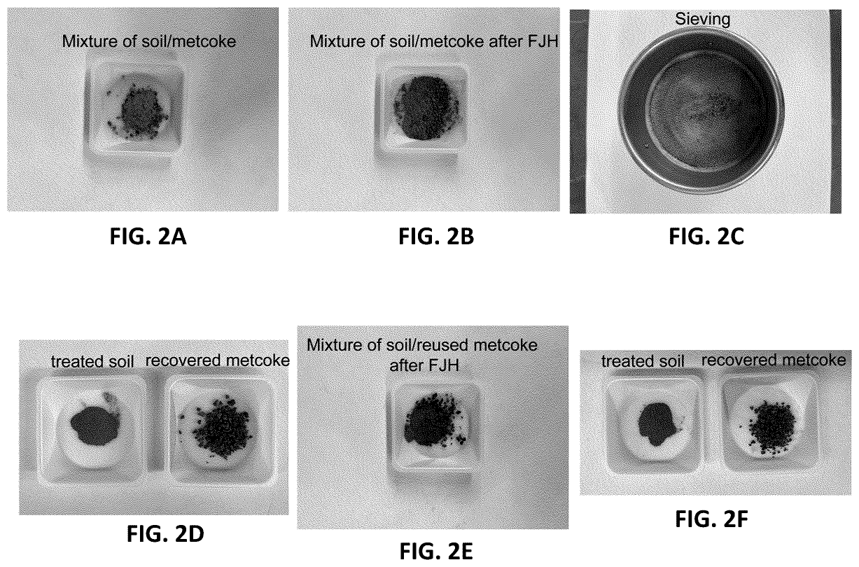

The residual carbon from the soil after the FJH process (HET process) can be separated by sieving based on the particle size difference between soil and the introduced carbon. By using metcoke as an example, the separation of the treated soil and residual metcoke was realized, with the carbon recovery yield of ˜92%. FIGS. 2A-2D.

Metcoke has a particle size larger than that of soil. FIG. 2A. After the FJH process, the particle size of the metcoke remained larger than that of the soil. FIG. 2B. Hence, the soil and metcoke were separated by sieving. FIGS. 2C-2D. For example, a mixture of soil and metcoke with a mass of m (soil)=334 mg and m (metcoke)=166 mg. After FJH, the remaining mass of soil and metcoke was m (soil+metcoke, FJH)=445 mg. After sieving separation, purified soil with a mass of m (purified soil)=293 mg and recovered metcoke with a mass of m (recovered metcoke)=152 mg was obtained, resulting in a recovery yield of metcoke of ˜92%. The ˜8% mass loss was believed to be attributed to consumption during the FJH process.

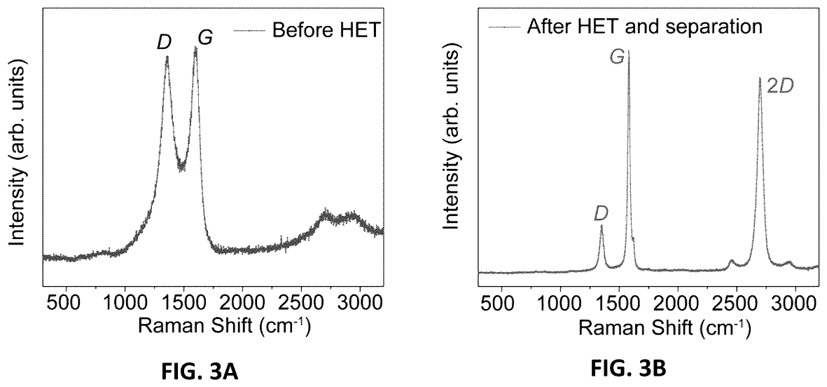

The recycled metcoke was converted into flash graphene (FIGS. 3A-3B), which has better conductivity and can be reused for the FJH process (FIGS. 2E-2F), greatly reducing the materials consumption. For example, the above-recovered metcoke (152 mg) and some fresh metcoke (14 mg) was then used as the conductive additive for a second FJH process. FIG. 2E. After a similar sieving separation, metcoke with a mass of m (recovered metcoke)=155 mg was recovered (FIG. 2F), resulting in a recovery yield of metcoke of ˜93%. This showed that simple sieving recycling could significantly reduce the consumption of conductive additive.

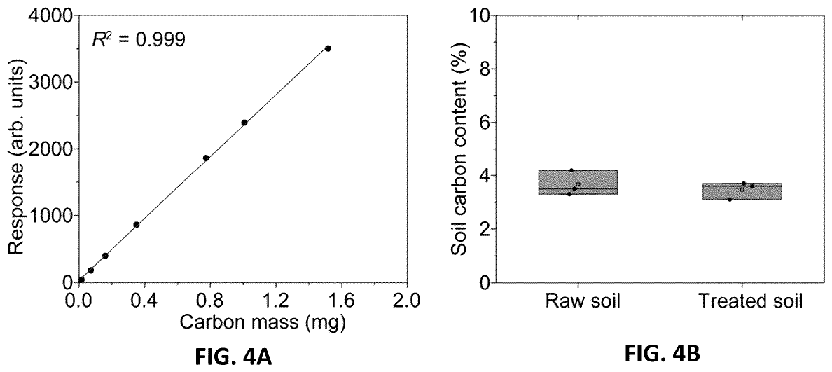

The soil carbon content in the raw soil and the treated soil was measured after separating carbon conductive additives. FIGS. 4A-4B. The carbon content in the treated soil was ˜3.5%, comparable to the raw soil (˜3.7%). The residual carbon additive can compensate for the organic carbon loss during the FJH process, resulting in a similar total carbon content in the treated soil and raw soil.

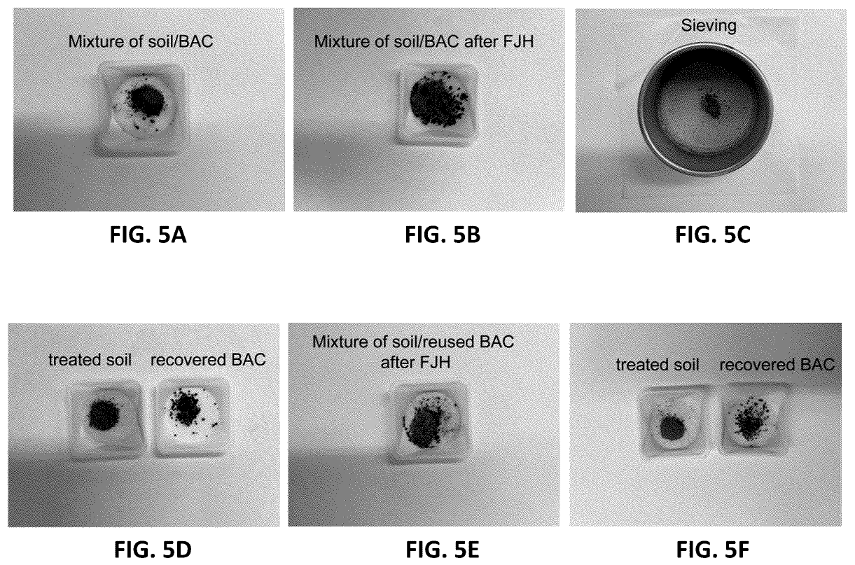

Other inexpensive carbon additives, such as bituminous activated charcoal (BAC), can also be used for the separation. FIGS. 5A-5F. A mixture of soil (˜200 mg) and BAC (˜100 mg) were used for the FJH process. FIG. 5A. After FJH purification and sieving process (FIGS. 5B-5C), the recovered mass of BAC was m (recovered BAC)=95.5 mg (FIG. 5D), resulting in a BAC recovery yield of ˜95.5%.

The recovered BAC can be reused for further FJH treatment. To show this, the recovered BAC (95.5 mg) with some new BAC (4.5 mg) was used as the conductive additives to purify another batch of soil (200 mg). FIG. 5E. After the FJH process and subsequent separation by sieving, BAC was recovered with a mass of m (recovered BAC)=93.2 mg (FIG. 5F), resulting in a BAC recovery yield of ˜93.2%.

### PFAS-Contaminated Soil

The FJH process can be utilized to remediate soil contaminated with persistent and bioaccumulative pollutants, such as soil contaminated with per- and polyfluoroalkyl substances (PFAS). The FJH process to remediate such soil contaminated with persistent and bioaccumulative pollutants, such as soil contaminated with per- and polyfluoroalkyl substances (PFAS) (“PFAS-contaminated soil”) can also be referred to as rapid electrothermal mineralization (REM) process.

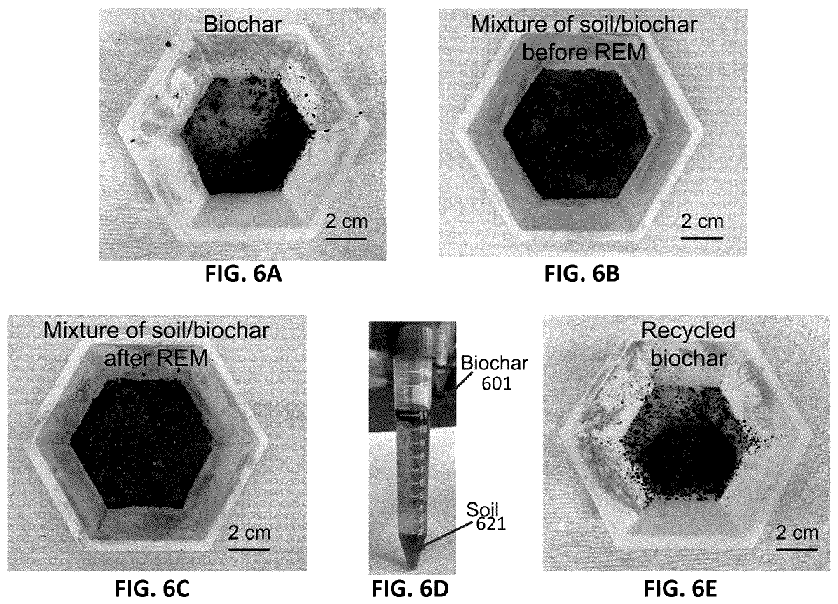

In such processes, the PFAS-contaminated soil is mixed with the conductive additive, such as biochar, to ensure appropriate electrical conductivity. After the FJH process (REM process), the used carbon additive can be separated from the soil mixture and then reused for next-batch soil remediation. For example, perfluorooctanoic acid (PFOA) is a particular type of PFAS. PFOA-contaminated soil and biochar with m (soil)=400 mg and m (biochar)=200 mg. FIGS. 6A-6B. After REM process, the remaining mass of mixture was m (mixture, REM)=476 mg. FIG. 6C. After centrifugation, filtering, and drying (FIG. 6D showing where biochar 601 floated and soil 602 sank), purified REM-treated soil with m (purified soil)=307 mg and recycled biochar with m (recycled biochar)=169 mg was obtained. FIG. 6E.

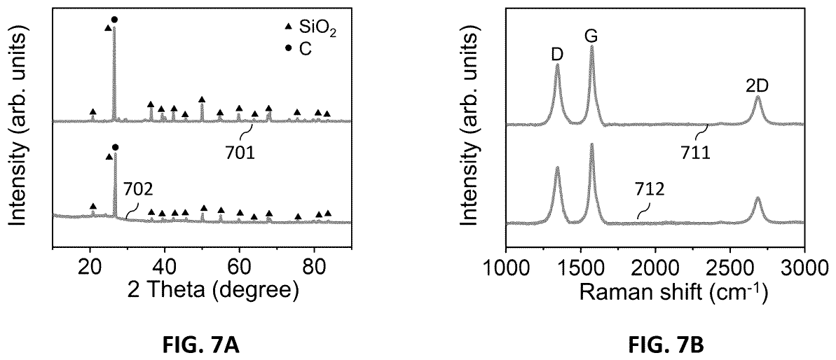

The biochar was flash Joule heated to enhance its conductivity and then used as the conductive additive. FIGS. 7A-7B show comparison of biochar and recycled biochar with lines 701-702 the XRD patterns for biochar and recycled biochar, respectively (FIG. 7A); and with lines 701-702 the Raman spectra for biochar and recycled biochar, respectively (FIG. 7B). No obvious composition differences were found between each other, proving the efficiency of the biochar recycling process. In this case, the biochar was pre-flashed before use, converting it into graphene, and that graphene was used as the conductive additive.

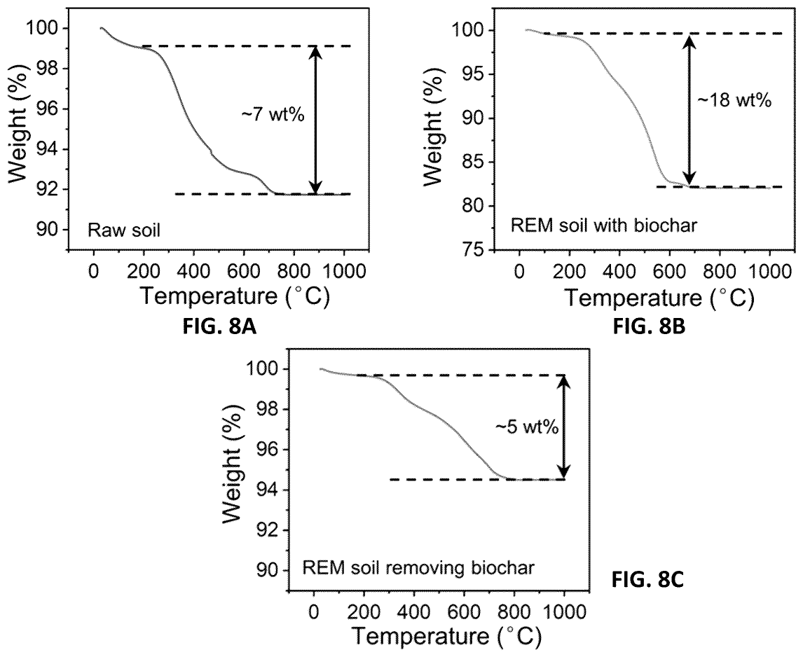

Per TGA results, for the raw soil, its weight loss comes from the decomposition of organic compounds, which accounts for ˜7 wt %. FIG. 8A. After mixing with biochar and treated by REM, the soil weight loss increases to ˜18 wt %, which results from the oxidation of carbon in biochar. FIG. 8B. After removing biochar by centrifugation and drying, the weight loss the REM soil decreased to a low value of ˜5 wt %, proving that the majority of the biochar in the soil has been successfully removed. FIG. 8C.

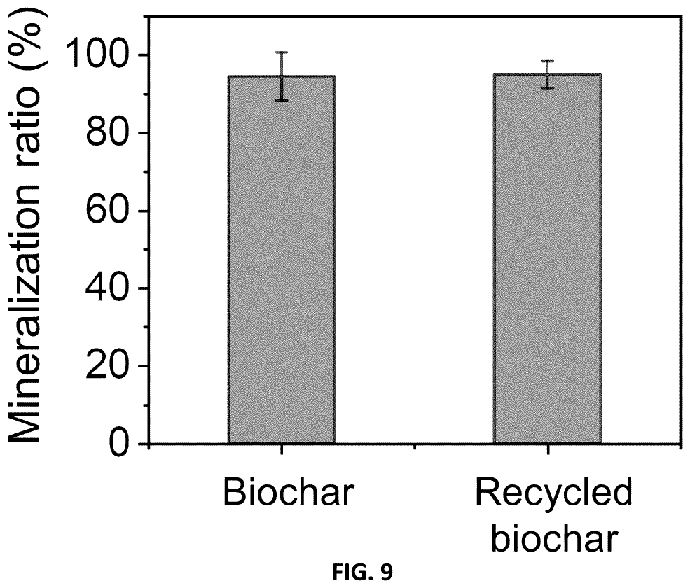

The biochar was separated from the soil by dispersion and centrifugation with a recycling ratio of ˜85 wt % (FIGS. 6A-6E, 7A-7B, and 8A-8C), and reused in a second REM processing with comparable PFAS mineralization performance (FIG. 9). FIG. 9 shows negligible change of the PFOA mineralization ratio (˜94%) either using biochar and recycled biochar as conductive additives, indicating the efficiency to reuse the recycled biochar in the REM process.

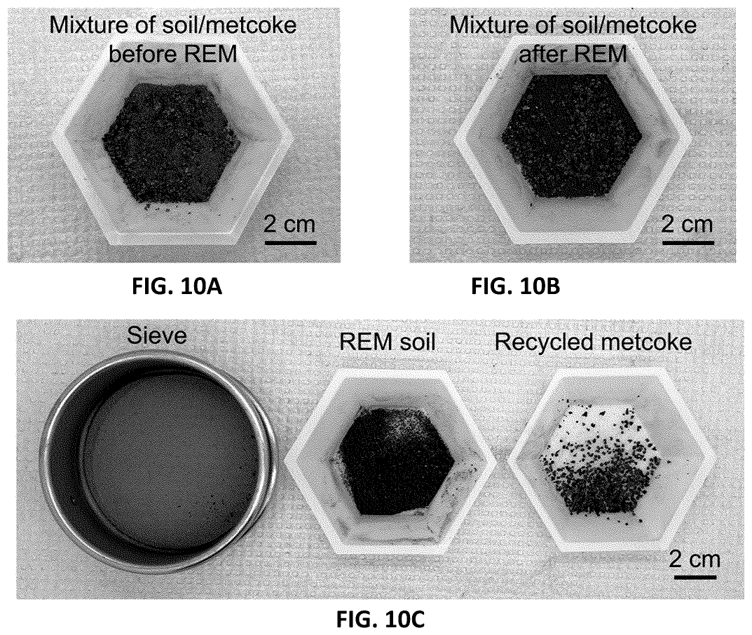

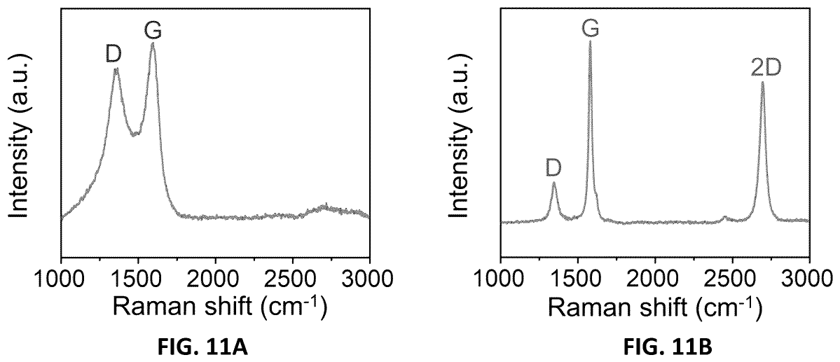

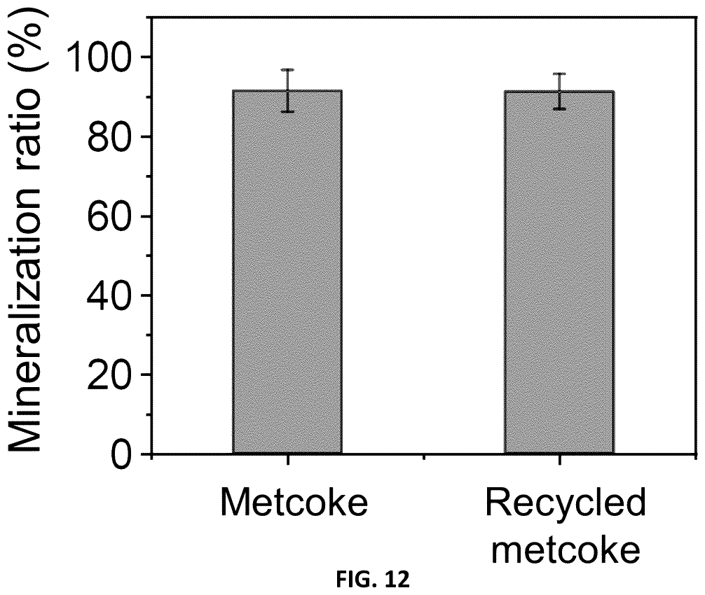

Similarly, when metcoke was used as the conductive additives, ˜91 wt % can be recycled after REM by simply sieving (FIGS. 10A-10C and 11A-11B) and then reused with similar performance (FIG. 12). For example, PFOA-contaminated soil and metcoke were mixed with m (soil)=400 mg and m (metcoke)=200 mg. FIG. 10A. After REM process, the remaining mass of mixture was m (mixture, REM)=473 mg. FIG. 10B. After sieving separation, purified REM-treated soil with m (purified soil)=287 mg and recycled metcoke with m (recycled metcoke)=186 mg were obtained. FIG. 10C. The recycling yield of metcoke was calculated to be ˜93 wt %. The Raman spectra of FIGS. 11A-11B shows that the initial metcoke converted to crystalline flash graphene during the REM process. When the recycled metcoke used as conductive additives, the PFOA mineralization ratio can also reach to a comparable value of ˜91%, indicating the efficiency to reuse the recycled metcoke in the REM process. FIG. 12. This significantly reduces materials consumption of the REM process while requiring greater processing.

### Recovery and Reuse for CFA

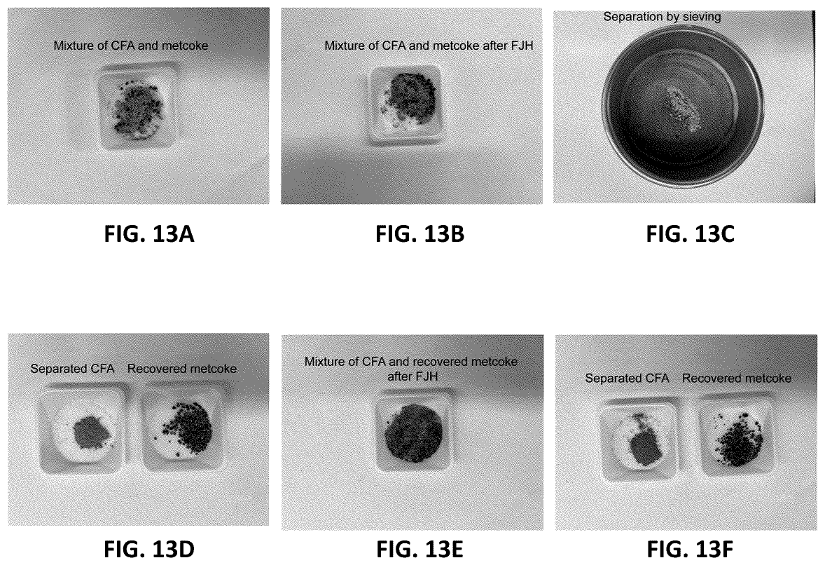

Based on the particle size and density differences between coal fly ash (CFA) and carbon, residual carbon from CFA can likewise be separated using physical processes. By using metcoke as an example, the separation of purified CFA and metcoke by sieving is shown. The CFA has fine particle size, and metcoke with relatively large size was utilized for analysis. The mixture of CFA (˜333 mg) and metcoke (˜167 mg) was used. FIG. 13A. After FJH, the particle size of CFA and metcoke remained almost unchanged. FIG. 13B. Thus, separation of CFA and metcoke by sieving was performed. FIG. 13C. In a typical process, the recovered mass of metcoke was m (recovered metcoke)=154 mg: which was a metcoke recovery yield of ˜92%. FIG. 13D.

The recovered metcoke can be reused as the conductive additive for further purification of CFA, which reduced the FJH purification cost. The recovered metcoke (154 mg) with some new metcoke (13 mg) as the conductive additives to purify the CFA (333 mg), as shown in FIG. 13E. After the FJH process and subsequent separation by sieving, the metcoke with mass of m (recovered metcoke)=156 mg was recovered and the metcoke recovery yield of ˜93%. FIG. 13F.

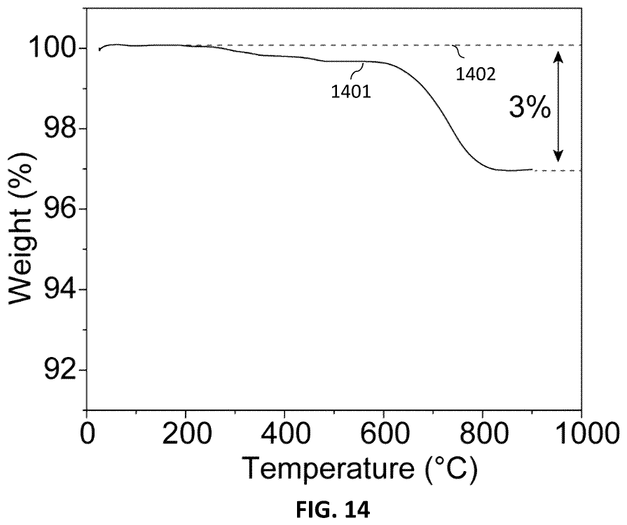

After the sieving separation process, the residual carbon content in the treated CFA (plot 1401) was reduced to ˜3%. See FIG. 14 (with dashed line 1402 for 100 wt %). The residual carbon could be completely removed by calcination in air. The choice of appropriate carbon removal approaches can depend on the landfilling or applications of the purified CFA.

Again, other inexpensive carbon additives, such as bituminous activated charcoal (BAC), can also be used for the separation. FIGS. 10A-10F. Similar to metcoke, BAC with relatively large size was utilized for analysis. The mixture of CFA (˜200 mg) and BAC (˜100 mg) was used. FIG. 10A. After FJH, the particle size of CFA and BAC remained unchanged. FIG. 10B. Thus, separation of CFA and BAC by sieving was performed. FIG. 10C. In a typical process, the recovered mass of BAC was m (recovered BAC)=95 mg, which was BAC recovery yield of ˜95%. FIG. 10D.

The recovered BAC can be reused for further FJH treatment. To show this, the recovered BAC (154 mg) with some new BAC (5.5 mg) as the conductive additives to purify the CFA (200 mg). FIG. 10E. After the FJH process and subsequent separation by sieving, BAC was recovered with mass of m (recovered BAC)=94 mg and the BAC recovery yield of ˜94%. FIG. 10F.

### Separation Process

TABLE I below reflects a summary of the recovery and reuse of conductive additives for the examples discussed and described above.

TABLE I
Recovery And Reuse Of Conductive Additives

| | | | Mass of | |
|---|---|---|---|---|
| | Mass of | Mass of | recovered | |
| | treated | conductive | conductive | Recovery |
| | materials | additive | additive | yield |
| Precursors | (mg) | (mg) | (mg) | (%) |
| Soil and metcoke | 334 | 166 | 152 | 92 |
| Soil and reused metcoke | 334 | 166 | 155 | 93 |
| Soil and BAC | 200 | 100 | 96 | 96 |
| Soil and reused BAC | 200 | 100 | 93 | 93 |
| Soil and biochar | 400 | 200 | 169 | 85 |
| Soil and metcoke | 400 | 200 | 186 | 93 |
| CFA and metcoke | 333 | 167 | 154 | 92 |
| CFA and reused metcoke | 333 | 167 | 156 | 93 |
| CFA and BAC | 200 | 100 | 95 | 95 |
| CFA and reused BAC | 200 | 100 | 94 | 94 |

With the exception of the soil and biochar example, the separation processes utilized were based upon sieving to separate the conductive carbon additive from the resultant products of the FJH process. The percentage yield of such sieving provided a recovery yield of at least 90%, and in embodiments was at least 92%, and still further embodiments at least 95%. The separation process for the soil and biochar example utilized centrifugation and drying, and resulted in a recovery yield of at least 85%.

Further and additional separation processes can be utilized to separate the conductive additive from the resultant products of the FJH process. For instance, the separation can be based upon grain size of the conductive additive and particle size of the resultant products of the FJH process. This can be sieving or other processes that separate materials based upon their size. Further for instance, the separation can be based upon difference in densities between the conductive additive and the resultant products of the FJH process. This can include utilizing a liquid (such as water) to separate the conductive additive from the resultant products of the FJH process. This can further include the conductive additive that can float at or near the top surface of the liquid utilized for separating, while the resultant products of the FJH process sink in the liquid (or vice versa). This can further include decanting and/or skimming the conductive additive (or the resultant products of the FJH process).

### Further Utilizations And Advantages

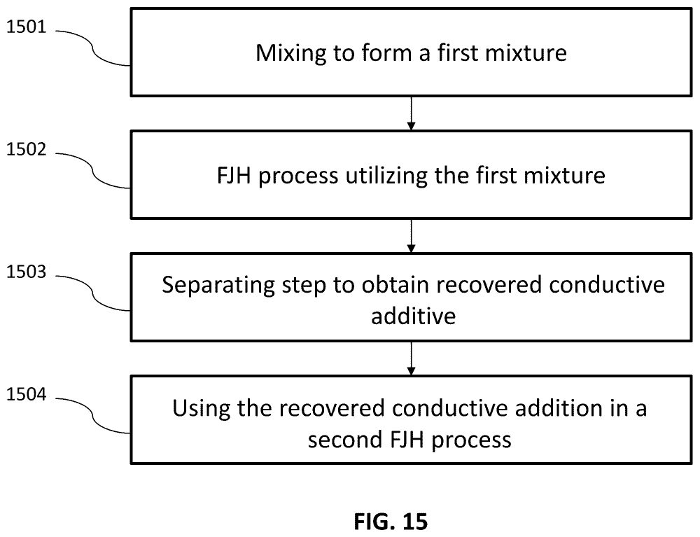

FIG. 15 is a flow diagram of an embodiment of a method of the present invention. In step 1501, the method mixes a first material with a conductive additive to form a first mixture. In step 1502, the method performs a flash Joule heating process of the first mixture to form a product. The product includes at least some of the conductive additive in the first mixture. In step 1503, the method separates at least some of the conductive additive from the product to obtain recovered conductive additive. In step 1504, the method uses the recovered conductive additive in a second flash Joule heating process. The conductive material is mixed with a second material for use in a second flash Joule heating process. The second material is the same or different material as the first material.

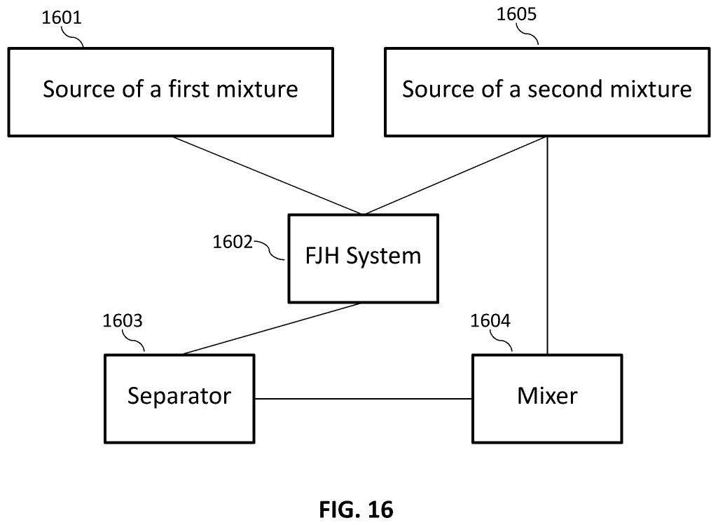

FIG. 16 is a schematic of an embodiment of a system of the present invention. The system that includes a source 1601 of a first mixture of a first material mixed with a conductive additive. The system further includes a flash Joule heating system 1602. Such flash Joule heating system can include (i) a cell operably connected to the first source such that the first mixture can be flowed into the cell and held under compression, (ii) electrodes operatively connected to pressure cell, and (iii) a flash power supply for applying a voltage across the mixture to perform a flash Joule heating process to form a product that includes at least some of the conductive additive of the first mixture. The system further includes a separator 1803 to separate some of the conductive additive from the product to obtain recovered conductive additive. The system further includes a mixer 1604 to mix the recovered conductive additive with a second material to form a second mixture. The second material is the same or different material as the first material. The system further includes a second source 1605 of the second mixture that is operable connected to the flash Joule heating system 1602 for use of the second mixture in the flash Joule system. Note that the flash Joule heating 1602 system can have multiple reactors for the flash Joule heating to occur, such that the system can perform the flash Joule heating of the first mixture from source 1601 in the same, or in a different, reactor as the system performs the flash Joule heating of the second mixture from source 1602. Moreover, the source of the first mixture 1801 can be the same as the source of the second mixture 1605.

These methods and systems to recover and reuse conductive additives for FJH can be used in a myriad of FJH processes, including the precious metals recovery from e-waste, heavy metals removal from e-waste and coal fly ash, heavy metals and organic pollutant removal from contaminated soil for soil remediation, rare earth recovery from coal fly ash, bauxite residue, and e-waste, etc. This separation and recovery of conductive additives from the treated materials can be utilized to reduce the material cost of the FJH processes. The conductive additives can be separated and recovered by a simple and energy-efficient process, such as sieving.

In addition to the waste mitigation and resource recovery, FJH has been used to synthesize various functional nanomaterials, including transition metal carbide nanocrystals, silicon carbide, corundum nanoparticles, molybdenum disulfides, boron nitride, etc. the recovery and reuse of the conductive additives can be used for the separation and purification of these materials as well.

Previous processes for the separation of residual carbon additives with the FJH-treated inorganic materials usually involve chemical processes, such as calcium etching or calcination. Separation processes such as sieving have the following advantages: (1) the sieving process is a physical process so the energy consumption is very small, while, in contrast, the chemical process involves high-temperature treatment which is energy consumptive: (2) the carbon additives could be recovered and reused with a high yield >95%: in contrast, the chemical process usually etches the carbon thus it cannot be reused. Moreover, the sieving process to recover and reuse the conductive additives is scalable.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. The scope of protection is not limited by the description set out above, but is only limited by the claims which follow, that scope including all equivalents of the subject matter of the claims.

The disclosures of all patents, patent applications, and publications cited herein are hereby incorporated herein by reference in their entirety, to the extent that they provide exemplary, procedural, or other details supplementary to those set forth herein.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the term “about” and “substantially” when referring to a value or to an amount of mass, weight, time, volume, concentration or percentage is meant to encompass variations of in some embodiments±20%, in some embodiments±10%, in some embodiments ±5%, in some embodiments±1%, in some embodiments±0.5%, and in some embodiments ±0.1% from the specified amount, as such variations are appropriate to perform the disclosed method.

As used herein, the term “substantially perpendicular” and “substantially parallel” is meant to encompass variations of in some embodiments within +10° of the perpendicular and parallel directions, respectively, in some embodiments within +5° of the perpendicular and parallel directions, respectively, in some embodiments within +1° of the perpendicular and parallel directions, respectively, and in some embodiments within +0.5° of the perpendicular and parallel directions, respectively.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

### REFERENCES

PCT International Patent Publication No. WO 2022/067111, entitled “Ultrafast Flash Joule Heating Methods And System For Performing Same,” to J. M. Tour, et al., filed Sep. 24, 2021 (the “Tour '111 PCT Application”).
Algozeeb, W. A., et al., “Flash graphene from plastic waste,” ACS Nano, 2020, 14, 15595-15604 (“Algozeeb 2020”).
Barbhuiya, N. H., et al., “The Future of flash graphene for the sustainable management of solid waste,” ACS Nano, 2021, 15, 15461-15470 (“Barbhuiya 2021”).
Chen, W., et al., “Millisecond conversion of metastable 2D materials by flash Joule heating,” ACS Nano, 2021, 15, 1282-1290 (“Chen I 2021”).
Chen, W., et al., “Ultrafast and controllable phase evolution by flash Joule heating,” ACS Nano, 2021, 15, 11158-11167 (Chen II 2021″).
Deng, B., et al., “Phase controlled synthesis of transition metal carbide nanocrystals by ultrafast flash Joule heating,” Nat. Commun . . . 2022, 13, 262 (“Deng I 2022”).
Deng, B., et al., “Rare earth elements from waste,” Sci. Adv., 2022, 8, eabm3132 (“Deng II 2022”).
Deng, B., et al., “High-surface-area corundum nanoparticles by resistive hotspot-induced phase transformation,” Nat Commun, 2022, 13, 5027 (Deng III 2022).
Deng, B., et al., “Urban mining by flash Joule heating,” Nat. Commun., 2021, 12, 5794 (“Deng 2021”).
Luong, D. X., et al., “Gram-scale bottom-up flash graphene synthesis,” Nature, 2020, 577, 647-651 (“Luong 2020”).
Stanford, M. G., et al., “Flash Graphene Morphologies,” ACS Nano, 2020, 14, 13691-13699 (“Stanford 2020”).
Wyss, K. M. et al., “Upcycling end-of-life vehicle waste plastic into flash graphene,” Communications Engineering, 2022, 1, 3 (“Wyss 2022”).
Wyss, K. M., et al., “Converting plastic waste pyrolysis ash into flash graphene,” Carbon, 2021, 174, 430-438 (“Wyss 2021”).

1. A method comprising:
(a) mixing a first material with a conductive additive to form a first mixture;
(b) performing a flash Joule heating process of the first mixture to form a product, wherein the product comprises a resultant conductive additive in the first mixture, wherein the resultant conductive additive is selected from the group consisting of
(i) the conductive additive,
(ii) a different conductive additive, and
(iii) a combination thereof;
(c) separating at least some of the resultant conductive additive from the product to obtain recovered conductive additive; and
(d) using the recovered conductive additive in a second flash Joule heating process, wherein
(i) the recovered conductive material is mixed with a second material for use in the second flash Joule heating process, and
(ii) the second material is the same or different material as the first material.

2-3. (canceled)

4. The method of claim 1, wherein the method further comprises:
(a) from a second product formed in the second flash Joule heating process, separating at least some of a second resultant conductive additive from the second product to obtain second recovered conductive additive; and
(b) using the second recovered conductive additive in a third flash Joule heating process,
(i) the second recovered conductive additive is mixed with a third material for use in the third flash Joule heating process, and
(ii) the third material is the same or different material as the first material and/or the second material.

5-6. (canceled)

7. The method of claim 1, wherein the first material is prepared from e-waste, ores, fly ash, soil, and/or bauxite residue.

8. (canceled)

9. The method of claim 1, wherein the first material is soil.

10. The method of claim 9, wherein the soil is a contaminated soil comprising a pollutant selected from the group consisting of heavy metals, persistent organic pollutants, and poly- and perfluorinated alkyl substances (PFAS).

11. The method of claim 10, wherein the pollutant is a heavy metal selected from the group consisting of lead (Pb), arsenic (As), zinc (Zn), cobalt (Co), cadmium (Cd), copper (Cu), mercury (Hg), and nickel (Ni).

12. The method of claim 10, wherein the pollutant is a persistent organic pollutant selected from group consisting of polycyclic aromatic hydrocarbons, polychlorinated biphenyl, organochlorine pesticides, total petroleum hydrocarbons, and PFAS.

13. The method of claim 9, wherein the soil is a contaminated soil comprising a persistent and bioaccumulative pollutant.

14. The method of claim 13, wherein the persistent and bioaccumulative pollutant comprises one or more per- and polyfluoroalkyl substances (PFAS).

15-24. (canceled)

25. The method of claim 1, wherein the step of separating at least some of the resultant conductive additive from the product to obtain recovered conductive additive is a sieving process.

26. The method of claim 1, wherein the step of separating at least some of the resultant conductive additive from the product to obtain recovered conductive additive is based upon grain size of the conductive additive and particle size of the product.

27. (canceled)

28. The method of claim 1, wherein the step of separating at least some of the resultant conductive additive from the product to obtain recovered conductive additive is based upon difference in densities between the conductive additive and the product.

29. The method of claim 28, wherein the step of separating comprises utilizing a liquid to separate the at least some of the resultant conductive additive from the product.

30-36. (canceled)

37. The method of claim 1, wherein recovery yield of the conductive additive is at least 85%, wherein the recovery yield of the conductive additive is weight of the recovered conductive additive recovered from the product divided by weight of the conductive additive in the first mixture.

38-40. (canceled)

41. A system comprising:
(a) a first source of a first mixture of a first material mixed with a conductive additive;
(b) a flash Joule heating system that comprises
(i) a cell operably connected to the first source such that the first mixture can be flowed into the cell and held under compression,
(ii) electrodes operatively connected to pressure cell, and
(iii) a flash power supply for applying a voltage across the mixture to perform a flash Joule heating process to form a product that comprises at a resultant conductive additive of the first mixture, wherein the resultant conductive additive is selected from the group consisting of
(A) the conductive additive,
(B) a different conductive additive, and
(C) a combination thereof;
(c) a separator to separate some of the resultant conductive additive from the product to obtain recovered conductive additive;
(d) a mixer to mix the recovered conductive additive with a second material to form a second mixture, wherein the second material is the same or different material as the first material; and
(e) a second source of the second mixture that is operable connected to the flash Joule heating system for use of the second mixture in the flash Joule heating system.

42-43. (canceled)

44. The system of claim 41, wherein the system is operable for separating and reusing the recovered conductive additive repeatedly for a plurality of additional Joule heating processes performed in series.

45. (canceled)

46. The system of claim 41, wherein the first material is prepared from e-waste, ores, fly ash, soil, and/or bauxite residue.

47. (canceled)

48. The system of claim 41, wherein the first material is soil.

49. The system of claim 48, wherein the soil is a contaminated soil comprising a pollutant selected from the group consisting of heavy metals, persistent organic pollutants, and poly- and perfluorinated alkyl substances (PFAS).

50-75. (canceled)

76. The system of claim 41, wherein the system has a recovery yield of the conductive additive that is at least 85%, wherein the recovery yield of the conductive additive is weight of the recovered conductive additive recovered from product divided by weight of the conductive additive in the first mixture.

77-79. (canceled)
